(19) United States
(12) Patent Application Publication
(10) Pub. No.: US 2007/0021885 A1
(43) Pub. Date: Jan. 25, 2007

(54) System and method for personalizing motor vehicle ride or handling characteristics

(75) Inventor: Wayne A. Soehren, Wayzata, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/188,599

(22) Filed: Jul. 25, 2005

(51) Int. Cl. G06F 17/00

(52) U.S. Cl. 701/36; 701/1

(57) ABSTRACT

An improved system and method for personalizing the ride and/or handling characteristics of a motor vehicle are disclosed. An example system for personalizing or individualizing the ride and/or handling characteristics of a motor vehicle is disclosed, which includes a processing unit, a memory unit, an interface unit, and a plurality of electronic control modules coupled to each other by a high speed data rate communications bus. The interface unit is also coupled to a read unit and a wireless input unit. The system can be operated in a centralized mode or a distributed mode. The read unit and wireless input unit can read in or receive, and forward to the interface unit, an individual's personal motor vehicle ride and/or handling characteristics data stored in a memory component of a device in that individual's possession. For example, an individual (e.g., driver, etc.) may carry a palm device (e.g., PDA, Palm Pilot®, etc.) including a memory component that stores that individual's personalized ride and/or handling characteristics data. The read unit can include, for example, a docking station for the palm device, which conveys the individual's personalized data from the memory component in the palm device to the interface unit. As another example, the individual may carry a cellular radiotelephone including a memory component. In this case, the wireless input unit can include, for example, a cellular radiotelephone or similar device that is compatible for operations with the individual's cellular device, and the individual can use the cellular device to transmit the individual's ride and/or handling characteristics data from the memory component to the interface unit via the wireless input unit. Thus, the processing unit and/or control modules can execute suitable algorithms for controlling the ride and/or handing characteristics of a motor vehicle, based on the individual's personalized data. Also, the use of a high speed data rate communications bus enables the system to meet future high speed data rate and processing requirements (e.g., drive-by-wire, etc.).

### FIELD OF THE INVENTION

The present invention relates generally to the automotive vehicle control field, and more specifically, but not exclusively, to an improved system and method for personalizing motor vehicle ride or handling characteristics.

### BACKGROUND OF THE INVENTION

In recent years, there has been a significant increase in the use of onboard electronic systems to control the operating characteristics of motor vehicles. In fact, modem automobiles and trucks may have as many as 50 onboard microprocessors to perform such functions as emissions control, fuel economy, operational and maintenance testing and diagnostics, as well as functions to increase driver and passenger safety, comfort and convenience. For example, modem automotive vehicles may have an Electronic Control Unit (ECU) to control engine operating parameters, an airbag control module to control the deployment of airbags, an Anti-Lock Braking System (ABS) module to control braking, an electronic traction-control or stability-control subsystem to improve handling, assist in cornering, and prevent skidding, an adjustable suspension subsystem to improve handling and ride comfort, and a transmission control module to control the shifting characteristics of the automatic transmission, just to name a few. Each of these modules, subsystems, ECUs, and similar vehicle control units can contain multiple microprocessors.

Notwithstanding all of the electronic systems and automated features provided by the manufacturers of today's motor vehicles, a drawback of these existing systems is that the individual operators of these motor vehicles are unable to readily configure their vehicles to provide the individual ride and/or handling characteristics they may desire. For example, Original Equipment Manufacturers (OEMs) of today's motor vehicles can program the microprocessors in their vehicles to provide distinctive ride and handling characteristics for the vehicles involved. Using electronic suspension control systems with sensors that monitor body and vehicle motions in response to road and driving conditions, OEMs can program, for example, the damping of a vehicle's suspension system in order to reduce body motion and increase tire contact with the road (e.g., traction) for all types of surfaces and conditions. Similarly, for example, using body and vehicle motion sensors (e.g., sensing steering angle, lateral acceleration, vehicle speed, etc.), OEMs can program the response of their vehicles' stabilizer systems and suspension systems to control filter dampening, yaw rates, and roll rates, in order to decrease the vehicle's roll during cornering and increase the overall comfort of the ride. In other words, automotive OEMs can program the processors in their vehicles to produce, for example, compact automobiles or other vehicles (e.g., trucks, SUVs, etc.) that have the ride and handling characteristics of luxury, full-size sedans.

However, once these ride and handling characteristics are programmed into a motor vehicle during its manufacture, there is no technique available to an individual (e.g., operator, passenger, owner of the motor vehicle) to electronically adjust or “tweak” its ride and/or handling characteristics to suit that individual's personal tastes. Albeit, operators of some existing motor vehicles have a limited capability in this regard and may press a switch to change from one driving mode (e.g., on-road, off-road, trailer) to another, or press another switch to select between discrete (e.g., two) levels of suspension damping. Nevertheless, it would be advantageous to provide an improved technique that an individual (e.g., driver, passenger, owner, etc.) may use to adjust the ride and/or handling characteristics of a motor vehicle in order to have the ride and/or handling of the vehicle more in line with, and suit, that individual's personal tastes. As described in detail below, the present invention provides at least one such system and method that can implement such a technique.

### SUMMARY OF THE INVENTION

The present invention provides an improved system and method for personalizing the ride and/or handling characteristics of a motor vehicle. In accordance with a preferred embodiment of the present invention, an example system for personalizing or individualizing the ride and/or handling characteristics of a motor vehicle is provided, which includes a processing unit, a memory unit, an interface unit, and a plurality of electronic control modules coupled to each other by a high speed data rate communications bus. The interface unit is also coupled to a read unit and a wireless input unit. The system can be operated in a centralized mode or a distributed mode. The read unit and wireless input unit can read in or receive, and forward to the interface unit, an individual's personal motor vehicle ride and/or handling characteristics data stored in a memory component of a device in that individual's possession. For example, an individual (e.g., driver, etc.) may carry a palm device (e.g., PDA, Palm Pilot®, etc.) including a memory component that stores that individual's personalized ride and/or handling characteristics data. The read unit can include, for example, a docking station for the palm device, which conveys the individual's personalized data from the memory component in the palm device to the interface unit. As another example, the individual may carry a cellular radiotelephone including a memory component. In this case, the wireless input unit can include, for example, a cellular radiotelephone or similar device that is compatible for operations with the individual's cellular device, and the individual can use the cellular device to transmit the individual's ride and/or handling characteristics data from the memory component to the interface unit via the wireless input unit. Thus, in accordance with the present invention, the processing unit and/or control modules can execute suitable algorithms for controlling the ride and/or handing characteristics of a motor vehicle, based on the individual's personalized data. Also, the use of a high speed data rate communications bus enables the system to meet future high speed data rate and processing requirements (e.g., drive-by-wire, etc.).

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of an example system for personalizing motor vehicle ride and handling characteristics, which can be used to implement a preferred embodiment of the present invention; and

FIG. 2 depicts a flow chart showing an exemplary method for personalizing an individual's motor vehicle ride and handling characteristics, in accordance with a preferred embodiment of the present invention.

### DETAILED DESCRIPTION OF PREFERRED EMBODIMENT

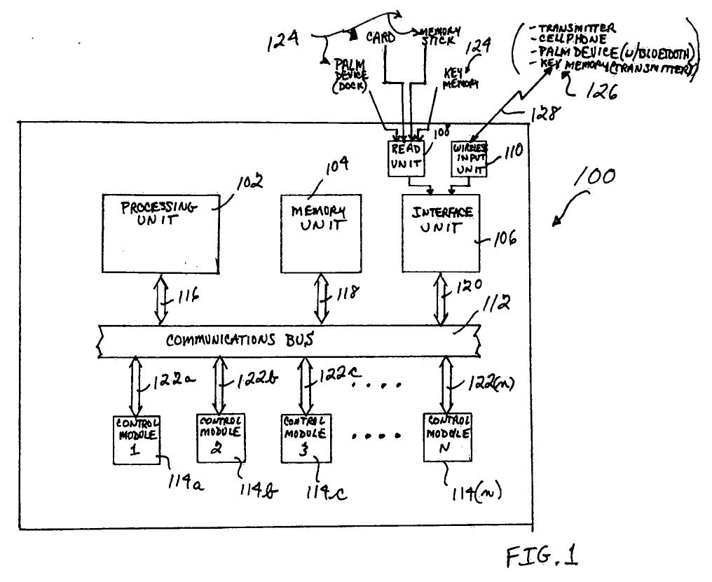

With reference now to the figures, FIG. 1 depicts a block diagram of an example system 100 for personalizing motor vehicle ride and handling characteristics, which can be used to implement a preferred embodiment of the present invention. For example, system 100 may be implemented with one or more microprocessors and/or suitable electronic modules as an OEM, after-market, or add-on system or subsystem in a motor vehicle. In any event, for this example embodiment, system 100 includes a processing unit 102 coupled to a communications bus 112 via an Input/Output (I/O) connection 116, a memory unit 104 coupled to communications bus 112 via an I/O connection 118, and an interface unit 106 coupled to communications bus 112 via an I/O connection 120. A read unit 108 and a wireless input unit 110 are coupled to interface unit 106 via suitable (e.g., low data rate) connections. Also, for this example, system 100 includes a plurality of vehicle control modules 114a-114(n) coupled to communications bus 112 via a plurality of respective I/O connections 122a-122(n). As shown, the parenthetical “n” in FIG. 1 denotes the nth vehicle control module or nth I/O connection of a plurality of “n” vehicle control modules or I/O connections. Thus, if system 100 were to be implemented with, for example, 10 vehicle control modules 114a-114(n) and 10 I/O connections 122a-122(n), then “n” for that example implementation would be equal to 10.

For this example embodiment, processing unit 102 can be a computer processor such as, for example, a microprocessor, digital signal processor, or any suitable processor capable of at least receiving and/or retrieving data (e.g., from interface unit 106 or memory unit 104) associated with personalized or individualized motor vehicle ride and/or handling characteristics, executing one or more vehicle control algorithms with the received and/or retrieved personalized or individualized motor vehicle ride and/or handling characteristics data to generate vehicle control data, and sending the resulting vehicle control data for the personalized or individualized ride and/or handling characteristics to one or more motor vehicle control modules or systems (e.g., one or more of vehicle control modules 114a-114(n)). For example, processing unit 102 can be arranged as a single processor or plurality of processors connected to a suitable data communications bus or system bus (e.g., communications bus 112). Also, for example, processing unit 102 can be implemented to operate in a centralized mode or distributed mode.

In a centralized mode of operations, processing unit 102 may receive ride and/or handling characteristics data from an input device (e.g., read unit 108 or wireless input unit 110 via interface unit 106), execute one or more suitable control algorithms to generate certain motor vehicle control functions, and communicate those motor vehicle control functions as control data to one or more of vehicle control modules 114a-114(n). In this case, the one or more recipient vehicle control modules 114a-114(n) could be electromechanical devices (e.g., sensors and actuators for stabilizer control, suspension control, steering control, traction control, engine torque management control, braking control, yaw rate control, roll rate control, anti-skid control, etc.) that directly implement the received control functions.

In contrast, for a distributed mode of operations, processing unit 102 may receive the ride and/or handling characteristics data from an input device, and forward that data to one or more vehicle control modules 114a-114(n). In the distributed case, each of the one or more vehicle control modules 114a-114(n) could be a microprocessor and/or an ECU coupled to a corresponding electromechanical device (e.g., sensors and actuators for stabilizer control, suspension control, steering control, traction control, engine torque management control, braking control, yaw rate control, roll rate control, anti-skid control, etc.). Thus, in a distributed mode, each of the one or more vehicle control modules 114a-114(n) can respond to the received ride and/or handling characteristics data by executing one or more suitable control algorithms to generate appropriate motor vehicle control functions, and communicating those motor vehicle control functions as control data to a respective electromechanical control device for implementation.

A memory controller/cache (not shown) can also be connected to the data communications bus or system bus (e.g., communications bus 112), which can provide an interface between processing unit 102 and a local memory (e.g., memory unit 104). As such, for this example embodiment, the local memory (e.g., memory unit 104) can be implemented with a Random Access Memory (RAM) or other suitable, alterable memory device. A plurality of machine instructions can be stored in the local memory and retrieved and operated on by processing unit 102 to generate vehicle control data for the one or more vehicle control modules or systems 114a-114(n) involved. Also, motor vehicle ride and/or handling characteristics data received from an input device (e.g., read unit 108 or wireless input unit 110) may be stored in the local memory (e.g., memory unit 104) to be retrieved and operated on by processing unit 102.

For one embodiment of the invention, an Input/Output (1/0) bus bridge can also be connected to the data communications bus or system bus (e.g., communications bus 112), which can provide an interface between processing unit 102 and an I/O bus. In such an example embodiment, I/O connections 122a-122(n), 116, 118 and 120 may form part of such an I/O bus. As such, processing unit 102 can receive, retrieve and/or send data via such an I/O bus and/or I/O connections 122a-122(n). In any event, those of ordinary skill in the art will appreciate that the hardware described herein for processing unit 102, memory unit 104, communications bus 112, and all of the other components of system 100 shown in FIG. 1 may vary. As such, the depicted example is provided for illustrative purposes and not meant to imply any architectural limitations with respect to the present invention.

For this example embodiment, interface unit 106 can be a microprocessor that functions primarily to receive ride and/or handling characteristics data at a relatively low data rate and execute one or more suitable algorithms to convert the received data from a low data rate to a high speed data rate. Notably, the requirements imposed for future onboard motor vehicle control applications include significantly higher data rates for high speed communications bus systems that are capable of supporting distributed control systems. In addition, these high speed communications bus systems are required to be fault tolerant and deterministic. For example, future motor vehicles will have drive-by-wire systems, in which processors will generate bus commands to direct the control of the vehicles (as opposed to direct mechanical control). Also, future motor vehicles will have steer-by-wire, brake-by-wire and other processor-controlled motor vehicle ride and/or handling functions. Such increased functionality requirements will impose increased requirements for the communications bus systems provided in the future motor vehicles, in terms of increased availability, reliability, and data bandwidth. Thus, in order to meet these future requirements, a primary function of interface unit 106 is to convert ride and/or handling characteristics received at a relatively low data rate to a suitable high speed data rate that is also compatible with the high speed communications bus systems to be found in future motor vehicles. An example of such a high speed data rate communications bus system that can be used for future motor vehicle requirements is the FlexRay® protocol and technology.

FlexRay® is a deterministic, fault-tolerant, high-speed communications bus system and protocol for motor vehicles, which has been developed by National Instruments Corporation of Austin, Tex. The FlexRay® protocol and technology are designed to meet future automotive requirements for dependability, availability, flexibility and a high data rate to complement existing onboard motor vehicle networking standards, such as the Controller Area Network (CAN), Time-Triggered Protocol (TTP), Time-Triggered Communication on CAN (TTCAN), Local Interconnect Network (LIN), and Media Orientated Systems Transport (MOST). Thus, with the increasing amount of data communications that will be required between the vehicles' processors and/or ECUs in future motor vehicles, it is important to provide a communications bus system that can provide such high data rates. For example, the FlexRay® communications bus system for motor vehicles is expected to provide a synchronous and asynchronous data transfer rate of approximately 10 Mbit/sec (although it is expected that higher data rates may be achieved).

As such, for this example embodiment, communications bus 112 is preferably implemented using a high speed data rate protocol, such as, for example, the FlexRay® communications bus protocol, and interface unit 106 is preferably implemented as a microprocessor that functions primarily to receive personalized motor vehicle ride and/or handling characteristics data from an input unit (e.g., read unit 108, wireless input unit 110), execute one or more suitable algorithms to convert the received personalized ride and/or handling characteristics data to a high speed data rate format (e.g., produce one or more message frames with personalized data in the FlexRay® communications bus protocol format), and send the formatted message frames to processing unit 102 via the high speed communications bus (e.g., communications bus 112). Alternatively, for another embodiment, interface unit 106 and communications bus 112 can be implemented using another suitable high speed communications bus protocol, such as, for example, a high speed CAN, TTCAN, TTP, etc. Thus, in accordance with the present invention, the use of a high speed data rate communications bus enables the system to meet future high speed data rate and processing requirements (e.g., drive-by-wire, etc.). However, although it is preferable (e.g., for increased technical advantages) that communications bus 112 be implemented with a high speed communications bus or system, the present invention is not intended to be so limited and can be implemented, for example, with a suitable medium speed or low speed data rate communications bus protocol (e.g., CAN, LIN, etc.).

For this example embodiment, read unit 198 can include one or more input devices that function primarily to read and receive personalized motor vehicle ride and/or handling characteristics data from an external device 124, which includes a memory component or similar source of stored data. For example, read unit 108 can be a docking device for a palm device (e.g., Personal Digital Assistant or PDA, Palm Pilot® device, etc.), which includes a memory component that stores an individual's personal data associated with a normalized set of motor vehicle ride and/or handling characteristics. As such, among other things, the docking device functions to convey the individual's personalized data from the memory component to interface unit 106. Also, for example, read unit 108 can be a magnetic card reader, which reads and receives an individual's personal data associated with a normalized set of motor vehicle ride and/or handling characteristics stored in a memory component of a magnetic card. Read unit 108 can also be a digital stick memory recorder/player, which reads and receives an individual's personal data associated with a normalized set of motor vehicle ride and/or handling characteristics stored in a digital stick memory card. Also, for example, read unit 108 can be a magnetic key reader, which reads and receives an individual's personal data associated with a normalized set of motor vehicle ride and/or handling characteristics stored in a memory component of an “intelligent” ignition key (e.g., the key and the ignition can act as conductive devices to transfer the personalized data stored in a memory component within the ignition key to interface unit 106). As such, read unit 108 can be implemented by using any suitable device capable of reading, retrieving and/or receiving an individual's personalized ride and/or handling characteristics data from an external device (e.g., 124) that includes a memory component capable of storing such data, and conveying that data via one or more conductors or conductive paths to a centralized processing system or distributed processing system (e.g., via interface unit 106 and communications bus 112).

A suitable data generation technique may be followed to create or change personalized ride and/or handling characteristics data for each individual, and store that data in an external device (e.g., external device 124). For example, an individual may sit in a motor vehicle (or motor vehicle simulator), and select personalized ride and/or handling characteristics based on the “feel” of the actual or simulated ride of that standard vehicle or simulated vehicle. Alternatively, for example, an individual may select personalized ride and/or handling characteristics from a “menu” of normalized ride and/or handling characteristics for a particular manufacturer's motor vehicle or model type of motor vehicle, or from a “menu” of standardized motor vehicle ride and/or handling characteristics (e.g., assuming that a suitable motor vehicle interface standard for personalizing ride and/or handling characteristics is developed for manufacturers). However, in any event, the presence or absence of an industry interface standard for personalized motor vehicle ride and/or handling characteristics does not impose any limitation on the scope of the present invention.

For this example embodiment, wireless input unit 110 can include one or more receiver components that function primarily to receive (e.g., via a wireless communications path 128) and personalized motor vehicle ride and/or handling characteristics data from a transmitter device 126, which includes a memory component for storing personalized data. Again, as described above, a suitable data generation technique may be followed to create personalized ride and/or handling characteristics data for each individual, and store that data in the memory component of such a transmitter device (e.g., transmitter device 126). For example, transmitter device 126 can be a transmitter device that is similar in function to a garage door opener or similar device, and can include a memory component that stores an individual's personal data associated with a normalized set of motor vehicle ride and/or handling characteristics. As such, among other things, the transmitter device 126 functions to convey the individual's personalized data from the memory component to interface unit 106 via the wireless communications path (e.g., radio link) 128 and wireless input unit 110. An individual (e.g., driver, passenger, etc.) can press a transmit button on the transmitter device to activate the transmitter and convey the stored data to a suitable receiver included in wireless input unit 110. Alternatively, for example, wireless input unit 110 can include an interrogator component that transmits an interrogation signal at selected intervals. A recipient device 126 can include an interrogation signal receiver/transmitter that receives the interrogator signal and can automatically respond by transmitting an individual's stored personalized data for reception by wireless input unit 110. Also, for example, wireless input unit 110 can be a wireless telephone receiver (e.g., remote phone, cellular telephone, etc.), which receives an individual's personal data associated with a normalized set of motor vehicle ride and/or handling characteristics stored in a memory component of a wireless device (e.g., remote phone, cellular telephone, etc.) 126. Wireless input unit 110 can also include, for example, a Bluetooth receiver (or receiver for a similar type of short range communications system) capable of receiving personalized data from a palm device (e.g., PDA, Palm Pilot®, etc.) 126 coupled to a Bluetooth transmitter, which can transmit an individual's personal data associated with a normalized set of motor vehicle ride and/or handling characteristics stored in a component memory of the palm device 126. Also, for example, wireless input unit 110 can be a receiver for a wireless key transmitter device (e.g., similar to a motor vehicle door/trunk locking/unlocking transmitter device), which receives an individual's personal data associated with a normalized set of motor vehicle ride and/or handling characteristics stored in a memory component of a wireless key transmitter device. As such, any suitable device capable of receiving personalized ride and/or handling characteristics data from a wireless transmitting device (e.g., 126) including a memory component capable of storing the personalized data, and conveying that data to a centralized processing system or distributed processing system (e.g., via interface unit 106 and communications bus 112), can be used to implement wireless input unit 110.

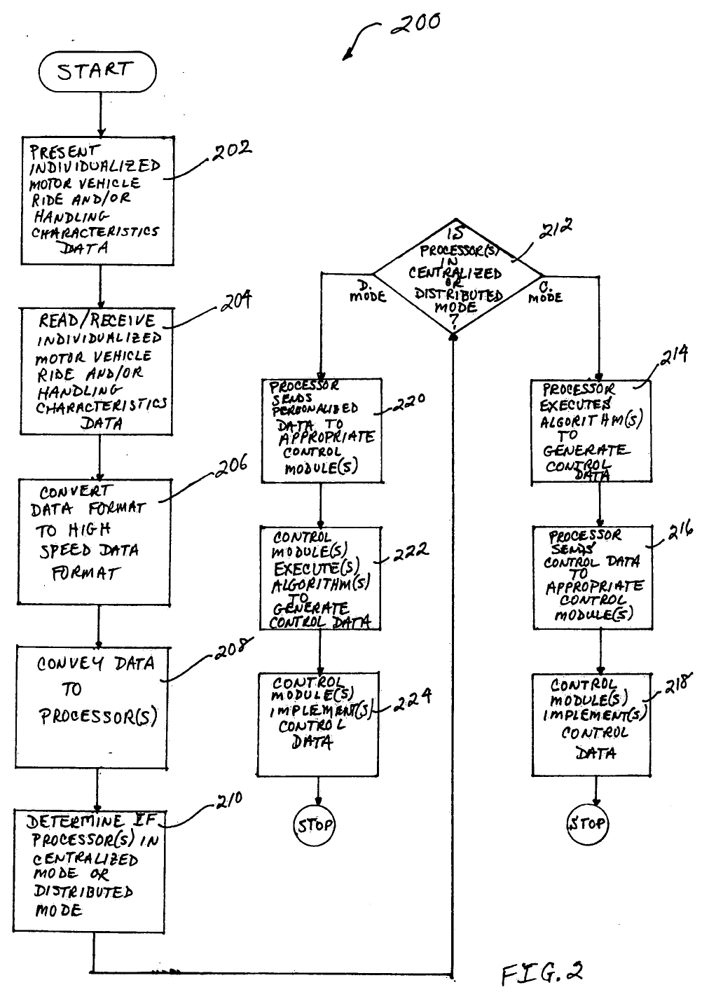

FIG. 2 depicts a flow chart showing an exemplary method 200 for personalizing an individual's motor vehicle ride and handling characteristics, in accordance with a preferred embodiment of the present invention. Referring to FIGS. 1 and 2, for this illustrative embodiment, an individual (e.g., driver, passenger, etc.) can present personal motor vehicle ride and/or handling characteristics information to system 100 (step 202). For example, an individual approaching a motor vehicle and desiring to adjust that vehicle's ride and/or handling characteristics to suit a personal taste can insert a palm device (e.g., device 124) into a suitable docking station (e.g., read unit 108) installed in that vehicle. That palm device includes memory in which that individual's personal ride and/or handling characteristics data are stored. As another example, as an individual approaches a motor vehicle, an interrogation transmitter installed in the motor vehicle emits an interrogation signal, which is received by a receiver in a remote device (e.g., device 126) including memory in which that individual's personal ride and/or handling characteristics data are stored. For example, that remote device can be a cellular phone or other type of radio transmitter/receiver device. In response to the interrogation signal, that remote device can transmit a signal including a security code (e.g., authentication code) and that individual's personal ride and/or handling characteristics data. If the security code transmitted from the remote device is valid (e.g., that code is received and authenticated by an interrogation receiver in the motor vehicle), then the process can be continued. If no valid security code is received, then the process is terminated.

Next, for this example, the individualized motor vehicle ride and/or handling characteristics data is read in or received by a suitable input device, such as read unit 108 or wireless input unit 110 (step 204). The input device is compatible and operable with the remote or external device (e.g., 124, 126) in which the individualized data is stored. The read in or received individualized ride and/or handling characteristics data is then converted (if necessary) to a communications format that is compatible with the communications bus or system used (step 206). For this example embodiment, the read in or received data is converted by a processor associated with interface unit 106 into a high speed data rate format (e.g., message formatted in accordance with the FlexRay® protocol). The formatted data is then forwarded from interface unit 106 to processing unit 102 via communications bus 112 (step 208). For example, interface unit 106 is capable of synchronously or asynchronously transmitting a suitable message including the personalized or individualized data in the high speed data rate format to processing unit 102. As an alternative, processing unit 102 can control the conveyance of the formatted message from interface unit 106 via communications bus 112.

Next, for this example embodiment, a determination is made about whether system 100 is implemented to operate in a centralized or distributed mode (step 210). In other words, for this example, is processing unit 102 or one or more of the individual control modules 114a-114(n) operable to execute one or more algorithms with the personalized ride and/or handling characteristics data received from interface unit 106 and generate control data? If system 100 and processing unit 102 are operating in a centralized mode (step 212), then processing unit 102 executes one or more algorithms with the received personalized ride and/or handling characteristics data, and generates control data as a result (step 214). For example, processing unit 102 can compare the received personalized ride and/or handling characteristics data with OEM-supplied ride and/or handling characteristics data stored in memory unit 104. The OEM-supplied data can provide the key parameters that can be adjusted for that particular motor vehicle involved. For one example, the OEM-supplied data may be used to control the dampening of the suspension system of the vehicle involved. Thus, for that example, processing unit 102 can generate suitable control signals to adjust the dampening of the suspension system of that vehicle within a reasonable range of the OEM-supplied data that does not affect the overall safety of the vehicle (e.g., provides control over 90% of the OEM-supplied range). Processing unit 102 then forwards the generated control data to the appropriate control module(s) for implementation of the personalized ride and/or handling characteristics (step 216). The recipient control module(s) 114a-114(n) respond by controlling the appropriate electromechanical device(s) (step 218), such as one or more actuators, to produce in the motor vehicle the ride and/handling characteristics desired by the individual.

Returning to step 212, for this example embodiment, if system 100 and processing unit 102 are operating in a distributed mode, then processing unit 102 can forward the received ride and/or handling characteristics data to one or more control modules (step 220). The one or more control modules (e.g., 114a-114(n)) can execute suitable algorithms with the received personalized ride and/or handling characteristics data, and generate appropriate control data as a result (step 222). For this example, a control module 114a-114(n) can compare the received personalized ride and/or handling characteristics data with OEM-supplied ride and/or handling characteristics data stored in memory unit 104. Again, the OEM-supplied data provides the key parameters that can be adjusted for that particular motor vehicle involved. For example, the OEM-supplied data may be used to control the dampening of the suspension system of the vehicle involved. Thus, the control module 114a-114(n) can generate suitable control signals to adjust the dampening of the suspension system of that vehicle within a reasonable range of the OEM-supplied data that does not affect the overall safety of the vehicle (e.g., provides control over 90% of the OEM-supplied range). The recipient control module(s) 114a-114(n) can then operate in accordance with the generated control signals to control the appropriate electromechanical device(s) (step 224), which produces in the motor vehicle the ride and/handling characteristics desired by the individual. As such, it should be understood that system 100 can also adjust other ride and/or handling characteristics, such as, for example, stabilizer control, suspension control other than dampening, steering control, traction control, engine torque management control, braking control, yaw rate control, roll rate control, anti-skid control, etc.).

It is important to note that while the present invention has been described in the context of a fully functioning system for personalizing motor vehicle ride and/or handling characteristics data, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular system.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A system for personalizing motor vehicle ride and handling characteristics, comprising:
a processing unit;
a memory unit;
an interface unit;
at least one control module; and
a communications medium, said communications medium coupled to said processing unit, said memory unit, said interface unit, and said at least one control module for communications of data there-between, whereby at least one of said processing unit and said at least one control module is operable to:
receive data representing at least one of personalized motor vehicle ride or handling characteristics;
execute at least one motor vehicle control algorithm with said received data; and
generate control data for adjusting one or more ride or handling characteristics of a motor vehicle, said control data associated with said received data.

2. The system of claim 1, further comprising:
a read unit coupled to said interface unit, said read unit operable to read in said data representing at least one of personalized motor vehicle ride or handling characteristics via a wired communications medium.

3. The system of claim 1, further comprising:
a wireless input unit coupled to said interface unit, said wireless input unit operable to receive said data representing at least one of personalized motor vehicle ride or handling characteristics via a wireless transmission or reception communications medium.

4. The system of claim 1, wherein said communications medium comprises a high speed communications bus.

5. The system of claim 1, wherein said communications medium comprises a FlexRay® communications bus.

6. The system of claim 1, wherein said processing unit and said at least one control module are operable in a distributed mode.

7. The system of claim 1, wherein said system is located in a motor vehicle.

8. The system of claim 1, wherein said interface unit is operable to:
receive said data representing at least one of personalized motor vehicle ride or handling characteristics;
convert a format of said received data to a message format according to a high speed data rate protocol; and
send a message including said converted format received data to said processing unit via a high speed data communications bus.

9. A motor vehicle system, comprising:
means for receiving data representing at least one of personalized motor vehicle ride or handling characteristics;
means for converting a format of said received data to a message format according to a high speed data rate protocol;
means for conveying a message including said converted data representing at least one of personalized motor vehicle ride or handling characteristics;
means for executing at least one motor vehicle control algorithm based on a reception of a message including said converted data representing at least one of personalized motor vehicle ride or handling characteristics, and generating control data associated with said at least one motor vehicle control algorithm; and
means for adjusting said at least one ride or handling characteristic of a motor vehicle in accordance with said generated control data.

10. A method for personalizing motor vehicle ride and handling characteristics, comprising the steps of:
receiving data representing at least one of personalized motor vehicle ride or handling characteristics;
communicating said received data to at least one of a processing unit or a vehicle control module;
executing at least one motor vehicle control algorithm with said received data; and
generating control data for adjusting one or more ride or handling characteristics of a motor vehicle, said control data associated with said received data.

11. The method of claim 10, further comprising the steps of:
coupling a read unit to an interface unit; and
reading in said data representing said at least one of personalized motor vehicle ride or handling characteristics.

12. The method of claim 10, further comprising:
coupling a wireless input unit to an interface unit; and
receiving said data representing said at least one of personalized motor vehicle ride or handling characteristics via a wireless receiver.

13. The method of claim 10, wherein the communicating step comprises communicating via a high speed communications bus.

14. The method of claim 10, wherein the communicating step comprises communicating via a FlexRay® communications bus.

15. The method of claim 10, wherein said at least one of a processing unit or a vehicle control module is operating in a distributed mode.

16. The method of claim 10, wherein said system is located in a motor vehicle.

17. The method of claim 10, further comprising the steps of:
receiving said data representing at least one of personalized motor vehicle ride or handling characteristics;
converting a format of said received data to a message format according to a high speed data rate protocol; and
sending a message including said converted format received data to at least one of a processing unit or a vehicle control module via a high speed data communications bus.

18. A computer program product, comprising:
a computer-usable medium having computer-readable code embodied therein for configuring a computer processor, the computer program product comprising:
a first executable computer-readable code configured to cause a computer processor to receive data representing at least one of personalized motor vehicle ride or handling characteristics;
a second executable computer-readable code configured to cause a computer processor to communicate said received data to at least one of a processing unit or a vehicle control module;
a third executable computer-readable code configured to cause a computer processor to execute at least one motor vehicle control algorithm with said received data; and
a fourth executable computer-readable code configured to cause a computer processor to generate control data for adjusting one or more ride or handling characteristics of a motor vehicle, said control data associated with said received data.

19. The computer program product of claim 18, further comprising:
a fifth executable computer-readable code configured to cause a computer processor to couple a read unit to an interface unit; and
a sixth executable computer-readable code configured to cause a computer processor to read in said data representing said at least one of personalized motor vehicle ride or handling characteristics.

20. The computer program product of claim 18, further comprising:
a seventh executable computer-readable code configured to cause a computer processor to couple a wireless input unit to an interface unit; and
an eighth executable computer-readable code configured to cause a computer processor to receive said data representing said at least one of personalized motor vehicle ride or handling characteristics via a wireless receiver.
